(19) United States
(12) Patent Application Publication
(10) Pub. No.: US 2007/0042615 A1
(43) Pub. Date: Feb. 22, 2007

(54) Land grid array socket

(75) Inventor: Fang-Jwu Liao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/507,890

(22) Filed: Aug. 22, 2006

(30) Foreign Application Priority Data
Aug. 22, 2005 (TW) 94128539

(51) Int. Cl. H01R 12/00

(52) U.S. Cl. 439/66

(57) ABSTRACT

A land grid array socket (10) includes a dielectric housing (20) defining a number of passages (204) between an upper surface (202) and a lower surface (206) thereof and a number of terminals (30) residing in corresponding passages, respectively. Each terminal includes a base portion (300) secured in the passage and a flexible arm (302) successively sticking out of the upper surface and the lower surface of the housing to define an upper contacting portion (3022) and a lower contacting portion (3026). The upper contacting portion defines multiple contacting areas, so as to establish reliable electrical connection between the terminal and a land grid array package (40) seated thereon.

### BACKGROUND OF THE INVENTION

1. Field of the Invention

The present invention generally relates to the field of electrical connectors. And more particularly, one embodiment of the present invention relates to a land grid array socket for forming reliable electrical connection between a land grid array package and a circuit substrate.

2. General Background

Land grid array sockets are widely used in various electrical devices to form electrical connection between a land grid array package and a circuit substrate. Basically, a land grid array socket has a dielectric housing defining a number of passages extending between two opposite surfaces thereof and a number of conductive terminals residing in corresponding passages, respectively. Each conductive terminal includes a base portion secured in the passage and a flexible arm integrally formed with the base portion. The flexible arm successively sticks out of two opposite surfaces of the housing to define an upper contacting portion and a lower contacting portion for mechanically and electrically mating with a land grid array package and a circuit substrate, respectively.

However, in the preceding prior design, only one contacting area is disposed on the upper contacting portion and the lower contacting portion. When the terminal is biased from its normal position with respect to the passage, electrical connection between the terminal and the land grid array package possibly cannot be ensured.

Therefore, there is a heretofore unaddressed need in the industry to address the aforementioned deficiencies and inadequacies.

### SUMMARY

According to an embodiment of the present invention, a land grid array socket includes a dielectric housing defining a number of passages extending between an upper surface and a lower surface thereof and a number of conductive terminals residing in the passages, respectively. Each terminal includes a base portion secured in the passage and a flexible arm successively projecting beyond the upper surface and the lower surface to define an upper contacting portion and a lower contacting portion. The upper contacting portion defines multiple contacting areas to form reliable electrical connection between the terminal and an electronic component seated thereon.

The embodiment of the present invention provides a land grid array socket having a number of conductive terminals each defining multiple contacting areas to mate with an electronic component placed thereon. Arrangement of multiple contacting areas of the conductive terminal ensures reliable electrical connection between the electronic component and the conductive terminal even in presence of deflection of the conductive terminal.

The present invention is illustrated by way of example and not limitation in the figures of the appended drawings, in which like references indicate identical elements, and in which:

### BRIEF DESCRIPTION OF THE DRAWINGS

FIG. 1 depicts an exemplary isometric, assembled view of a land grid array socket in accordance with an embodiment of the present invention, wherein a conductive terminal has not been planted in a dielectric housing;

FIG. 2 depicts an exemplary enlarged view of a circled portion 2 shown in FIG. 1;

FIG. 3 depicts an exemplary enlarged view of the conductive terminal shown in FIG. 1;

FIG. 4 depicts an exemplary enlarged view of the conductive terminal shown in FIG. 1 from another aspect; and

FIG. 5 depicts an exemplary cross-sectional view of the land grid array socket of FIG. 1 along line 5-5, wherein an upper contacting portion and a lower contacting portion of the conductive terminals are in mechanical and electrical engagement with an electronic component and a circuit substrate, respectively.

### DETAILED DESCRIPTION OF THE EMBODIMENT

In the following description, for purpose of explanation, numerous details are set forth in order to provide a thorough understanding of the embodiment of the present invention. However, it will be apparent to one skilled in the art that these specific details are not required in order to practice the embodiment of the present invention.

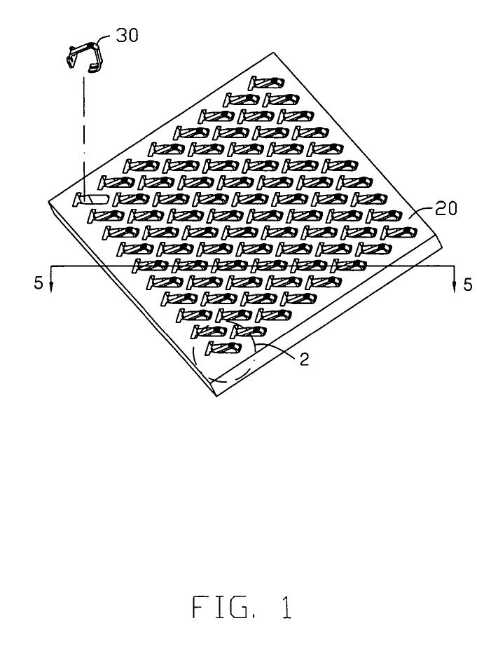

Referring to FIG. 1 to FIG. 5, a land grid array socket 10 in accordance with an embodiment of the present invention includes a dielectric housing 20 having a number of passages 204 and a number of conductive terminals 30 seated in corresponding passages 204, respectively. The terminal 30 includes a base portion 300 secured in the passage 204 and a flexible arm 302 successively protruding out of the housing 20 so as to define an upper contacting portion 3022 and a lower contacting portion 3026. The upper contacting portion 3022 defines two spaced contacting areas (not labeled).

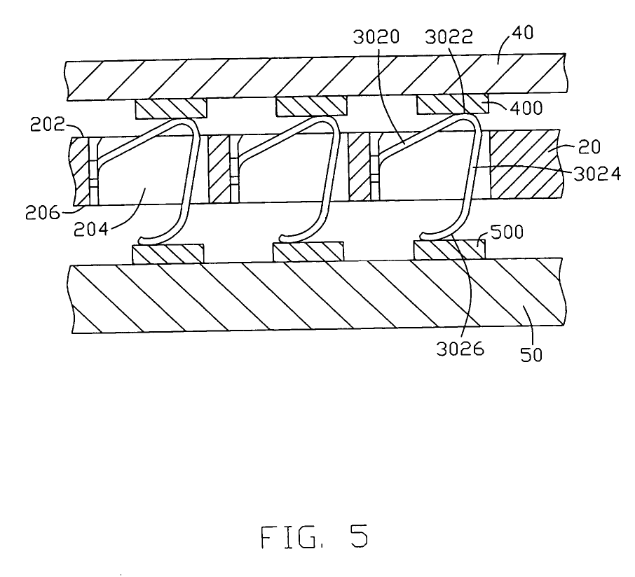

Individual elements of the land grid array socket 10 will now be described in greater detail. As shown in FIG. 1 and FIG. 5, the elongated dielectric housing 20 may be molded of plastic material or the like and includes an upper surface 202 and an opposite lower surface 206. A number of passages 204 extending throughout the upper surface 202 and the lower surface 206 of the housing 20 is arranged in a matrix fashion. Each passage 204 includes a narrow retaining slot 2040 and a wide receiving slot 2042 communicated to the narrow retaining slot 2040.

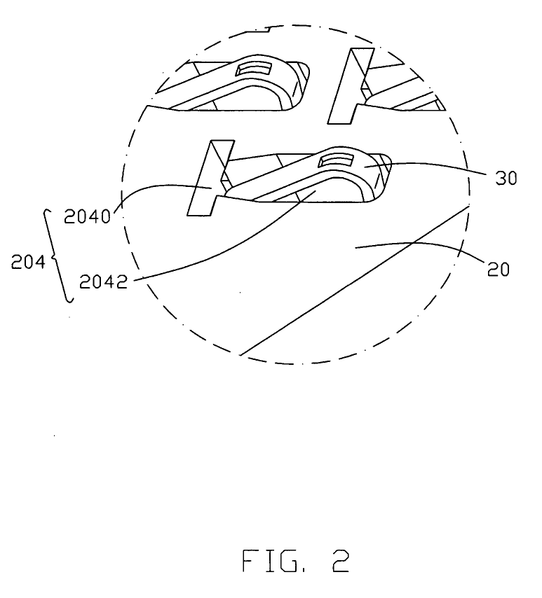

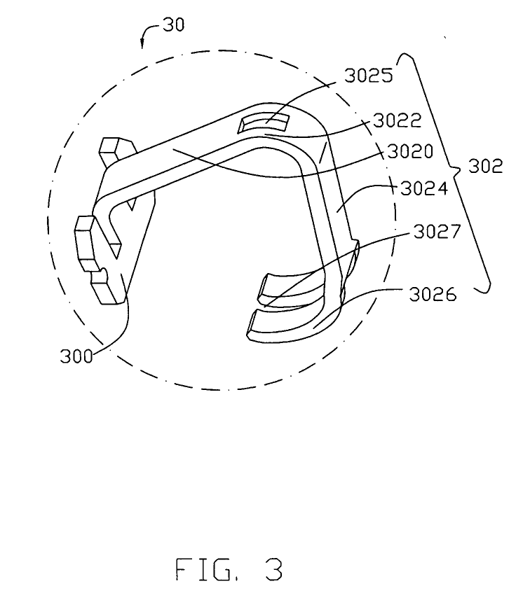

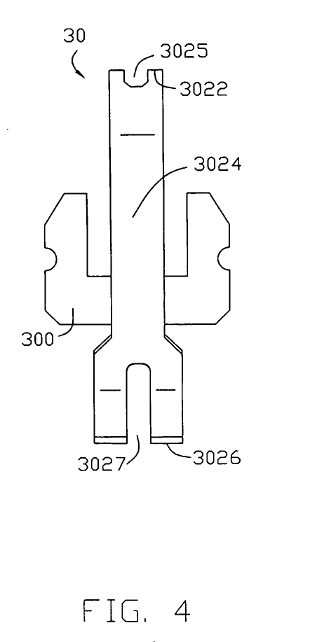

As best shown in FIG. 2 and FIG. 3, the conductive terminal 30 includes a base portion 300 formed with a number of barbs (not labeled) at opposing lateral sides thereof and a flexible arm 302 integrally formed with the base portion 300. The flexible arm 302 includes an upper beam 3020 extending upwardly away from the base portion 300 and a lower beam 3024 extending downwardly toward the base portion 300 from a distal end of the upper beam 3020. An upper contacting portion 3022 is situated at a joint of the upper beam 3020 and the lower beam 3024. A lower contacting portion 3026 is disposed at a distal end of the lower beam 3024. The upper contacting portion 3022 is recessed at a center thereof to define two spaced contacting areas. In an alternative form of the present embodiment, the upper contacting portion 3022 can also have a through-hole at a center thereof to define two spaced contacting areas. It should be understood that the lower contacting portion 3026 of the conductive terminal 30 could also have discrete contacting areas via defining a slot 3027 at a center thereof. Additionally, as shown in FIG. 4, the upper contacting portion 3022 has a lateral outer dimension which is smaller than that of the lower contacting portion 3026.

When the terminal 30 is inserted in the passages 204, the base portion 300 of the terminal 30 is secured in the narrow slot 2040. The flexible arm 302 of the terminal 30 extends to and resides in the wide receiving slot 2042, with opposing lateral sides thereof being spaced from the sidewalls of the receiving slot 2042. The upper contacting portion 3022 and the lower contacting portion 3026 of the flexible arm 302 stick out of the upper surface 202 and the lower surface 206 of the housing 20, respectively. When the land grid array socket 10 is sandwiched between an electronic component, such as a land grid array package 40, and a circuit substrate 50, the upper contacting portion 3022 of the terminal 30 electrically contacts with a conductive pad 400 of the package 40. The lower contacting portion 3026 of the terminal 30 resiliently abuts against a conductive element 500 on the circuit substrate 50, thereby forming an electrical route between the land gird package 40 and the circuit substrate 50.

In connection with the preceding description, the conductive terminal 30 in accordance with the embodiment of the present invention can provide multiple contacting points to mate with the land grid array package 40 placed thereon, which possibly can ensure reliable electrical connection between the conductive terminal 30 and the land grid array package 40 even in presence of deflection of the terminal 30.

It should be noted that, as is known in the art, the contacting portions 3022, 3026 of the conductive terminal 30 can be configured to have multiple contacting areas via other means well known to one ordinary skilled in the art, for instance via a number of protrusions integrally formed on the contacting portions 3022, 3026.

While the present invention has been illustrated by description of embodiment thereof, and while the embodiment have been described in considerable detail, it is not intended to restrict or in any way limit the scope of the appended claims to such details. Additional advantages and modifications in the spirit and scope of the present invention will readily appear to one skilled in the art. Therefore, the present invention is not limited to the specific details and illustrative examples shown and described.

1. A land grid array socket, comprising:
a dielectric housing defining a plurality of passages extending between an upper surface and a lower surface thereof; and
a plurality of conductive terminals disposed in corresponding passages, respectively, each terminal comprising a base portion secured in the passage and a flexible arm integrally formed with the base portion, the flexible arm successively protruding beyond the upper surface and the lower surface of the housing to form an upper contacting portion and a lower contacting portion, the upper contacting portion having multiple contacting areas to ensure reliable electrical connection between the terminal and an electronic component seated thereon.

2. The land grid array socket of claim 1, wherein the upper contacting portion of the terminal is recessed at a center thereof to define two spaced contacting areas.

3. The land grid array socket of claim 1, wherein the upper contacting portion of the terminal has a through-hole at a center thereof to define two spaced contacting areas.

4. The land grid array socket of claim 1, wherein each passage in the housing comprises a narrow retaining slot and a wide receiving slot in communication with each other, the base portion of the terminal is retained in the narrow retaining slot, and the flexible arm of the terminal extends to and resides in the wide receiving slot.

5. The land grid array socket of claim 4, wherein the flexible arm of the terminal is spaced from sidewalls of the receiving slot.

6. The land grid array socket of claim 1, wherein the flexible arm of the terminal comprises an upper beam extending upwardly away from the base portion and a lower beam extending downwardly toward the base portion from a distal end of the upper beam, the upper contacting portion is situated at a joint of the upper beam and the lower beam, and the lower contacting portion is positioned at a distal end of the lower beam.

7. The land grid array socket of claim 1, wherein the lower contacting portion of the terminal defines multiple discrete contacting areas.

8. A conductive terminal, comprising:
a base portion; and
a resilient arm integrally formed with the base portion, the resilient arm having an upper beam projecting upwardly away from the base portion and a lower beam extending downwardly toward the base portion from a distal end of the upper beam, the resilient arm defining an upper contacting portion at a junction of the upper beam and the lower beam and a lower contacting portion at a distal end of the lower beam, the upper contacting portion defining multiple discrete contacting areas to form reliable electrical engagement with an electronic component placed thereon.

9. The conductive terminal of claim 8, wherein the lower contacting portion comprises multiple contacting areas.

10. The conductive terminal of claim 8, wherein the upper contacting portion defines a recess at a center thereof.

11. The conductive terminal of claim 8, wherein the upper contacting portion defines a through-hole at a center thereof.

12. The conductive terminal of claim 8, wherein the base portion forms a plurality of barbs at two lateral sides thereof.

13. The conductive terminal of claim 8, wherein the upper contacting portion has a lateral outer dimension smaller than that of the lower contacting portion.

14. An electrical connector comprising:
an insulative housing defining a plurality of passageways extending therethrough vertically, each of said passageways including a small retention recess and a large body opening;
a plurality of contacts respectively disposed in the corresponding passageways, each of the contacts including:
a base section received in the corresponding retention recess,
a resilient arm extending from the base section and defining upper and lower contact regions, along a longitudinal direction of said resilient arm, exposed to an upper face and a lower face of the housing; wherein
at least one of said upper and lower contact regions is divided into two areas spaced from each other in a transverse direction perpendicular to said longitudinal direction.

15. The connector as claimed in claim 14, wherein one of said upper and lower contact regions is closer to the retention recess than the other.
